(19) United States
(12) Patent Application Publication
(10) Pub. No.: US 2024/0351435 A1
(43) Pub. Date: Oct. 24, 2024

(54) Single-Track Vehicle With a Vehicle State Display

(71) Applicant: Bayerische Motoren Werke Aktiengesellschaft, Muenchen (DE)

(72) Inventors: Frederic PFEUFFER, Freising (DE); Harry SCHMIDT, Muenchen (DE); Dominik WOERLE, Muenchen (DE)

(21) Appl. No.: 18/689,599

(22) PCT Filed: Sep. 23, 2022
(86) PCT No.: PCT/EP2022/076487

§ 371 Date: Mar. 6, 2024

(30) Foreign Application Priority Data
Oct. 14, 2021 (DE) 10 2021 126 623.8

(51) Int. Cl. B60K 35/00

(52) U.S. Cl. CPC B60K 35/00; B60K 2360/332; B60K 2360/334

(57) ABSTRACT

A single-track vehicle has a vehicle state display and a controller. The vehicle state display includes at least one projection surface, a cover, and at least one lighting device. The at least one lighting device is coupled to the controller, and the at least one lighting device and the cover are arranged such that light emitted from the lighting device can only be perceived indirectly from outside of the vehicle. The lighting device is designed to generate at least one first light pattern corresponding to a first vehicle state and a second light pattern corresponding to a second vehicle state on the projection surface on the basis of control signals of the controller. The first light pattern and the second light pattern are different.

### BACKGROUND AND SUMMARY

The present invention relates to a single-track vehicle with a vehicle state display.

For users of vehicles, the fastest and most direct way of being able to comprehend pieces of information about various vehicle states is usually in a visual way. Single-track vehicles face a challenge, however, in that such vehicles usually do not have a closable passenger compartment. Road users, including those that are not occupants or passengers of the respective vehicle, may then be influenced unreasonably on account of visual display means used to convey information.

Therefore, the invention is based on the object of providing the possibility of visually conveying information for single-track vehicles outside the vehicle display in a manner that prevents road users from being influenced unreasonably.

The object is achieved by means of the subject matter of the independent patent claim. Advantageous configurations are specified in the dependent patent claims and the following description, each of which may constitute aspects of the invention by themselves or in (sub) combination.

In accordance with one aspect, a vehicle, in particular a single-track vehicle, with a vehicle state display and a controller is provided. The vehicle state display comprises at least one projection surface, a cover and at least one illuminant. The at least one illuminant is coupled to the controller. The at least one illuminant and the cover are arranged in such a way that light emitted by the at least one illuminant is perceptible only indirectly from outside the vehicle. The illuminant is designed to generate at least one first light image corresponding to a first vehicle state and a second light image corresponding to a second vehicle state on the projection surface on the basis of control signals of the controller. The first light image and the second light image are different.

In the present case, a single-track vehicle is understood to mean vehicles such as, for example, electric scooters, e-scooters, motorcycles, motorbikes and at least partly motor-driven two-wheeled vehicles with single or double front- or rear-wheel steering. Furthermore, the term at least also encompasses such vehicles which only comprise such passenger compartments which cannot be closed, i.e. quad bikes or trikes, for example. Other vehicles comprising at least one passenger compartment that is closable at times, such as cabriolets, for example, are not encompassed.

Vehicles can be at least partly electrically driven and/or have an internal combustion engine.

In the present case, a light image is understood to mean an image representation which is generated on the at least one projection surface and which comprises at least one piece of information that is visually perceptible to a human. In other words, if only material underlying the projection surface is visually perceptible to a human, no light image is present. A switched-off illuminant thus cannot generate a light image. Therefore, the illuminant and the vehicle states correspondingly made available should also not be understood to mean just backlighting, since the latter does not provide different light images corresponding to different vehicle states on the basis of control signals of a controller.

The controller is at least indirectly coupled to further electrical or electronic components of the vehicle. Accordingly, the controller obtains pieces of information about different vehicle states and/or vehicle parameters. The controller is then designed to control the at least one illuminant with the aid of control signals in such a way that different light images can be generated in a manner corresponding to the different vehicle states.

The controller is e.g. the central control unit of the vehicle, having access to all state data of the vehicle.

The projection surface is provided in particular in the region of the lateral outer skin of the vehicle and at a distance from the display.

By way of example, different vehicle states can represent different states of charge of an energy storage device of the vehicle, which are presented on the basis of specific light images.

The vehicle designed in this way makes it possible for different pieces of information concerning the vehicle to be made available visually to a human in a simple and direct way, without the user being bothered by the underlying light images.

In particular, the vehicle states are provided in a manner capable of homologation. To put it another way, the vehicle states are provided in compliance with the ECE (Economic Commission for Europe) R53 standard. The vehicle states are provided in particular in a manner capable of homologation for class L3 vehicles, i.e. for two-wheeled motorbikes with a swept volume of more than 50 cm³ in the case of internal combustion engines and/or a design-dictated maximum speed of more than 45 km/h.

Illuminants not provided by an original equipment manufacturer (OEM) can in principle be arranged in a manner capable of homologation. However, such illuminants cannot represent different vehicle states by means of corresponding light images in a manner capable of homologation, since they cannot be coupled to a controller of the underlying vehicle for this functionality. These deficiencies are rectified in the present case. As a result, the information content that can be conveyed is advantageously increased, the pieces of information being easily and directly comprehensible to a human.

Preferably, the projection surface is provided in a gap of the outer skin of the vehicle, in particular a gap on a side surface of the vehicle, e.g. between the seat and underlying frame or, if present, the frame covering.

Optionally, the light emitted by the at least one illuminant can be perceptible to a human from surroundings of the vehicle not in an unreflected manner and/or not in an unrefracted manner and/or not in an undiffracted manner. That means that the surroundings of the vehicle that are reachable by a human are shielded from the illuminant, for example with the aid of the cover, in such a way that direct incidence of light (unreflected/unrefracted/undiffracted) from the illuminant into the human eye is prevented.

In particular, a spatial region between the illuminant and the projection surface corresponding to a projection direction of the illuminant may be unreachable for the human eye. The surroundings therefore relate to that spatial region from which a direct view into the illuminant is prevented, for example with the aid of the cover. As a result, the capability of homologation for the illuminant is reliably ensured since direct incidence of light into a human eye is prevented.

Alternatively or additionally, an interspace can be arranged between the at least one projection surface and the cover. The interspace is then delimited for the vehicle at least partly along a vertical direction by the cover and a further component of the vehicle, the further component being situated opposite the interspace. Consequently, the surrounding components of the vehicle limit access to the spatial region between the illuminant and the projection surface, for which reason the possibility of direct perception of light for a human is correspondingly reliably avoidable.

The interspace can be delimited at least partly along the vertical direction if the vehicle is arranged according to an upright position. In this case, the upright position of the vehicle corresponds to a positioning of the vehicle according to the customary manner of use. By way of example, the upright position can be attained if a parking device is not used, rather the position according to travel straight ahead is attained. If a parking device is used, then the upright position is usually at least partly attained, such that the interspace is delimited at least partly according to the vertical direction.

Preferably, the at least one projection surface and the cover are arranged in such a way that a light image generated on the at least one projection surface by the at least one illuminant is perceptible from the surroundings of the vehicle. In particular, the generated light image is perceptible indirectly or directly from the side of the vehicle. The capability of homologation is not affected if the direct view of the generated light image is undisturbed. Therefore, although a direct view of the illuminant is prevented by corresponding geometric arrangement of the cover, there is no need to prevent a direct view of the generated light image. Consequently, represented pieces of information which present different vehicle states can be perceived particularly reliably by a human.

Advantageously, an at least partly overlapping region of the projection surface can be provided, within which the first light image and the second light image are at least partly generated. That means that different light images can be generated at least partly in a single region of the projection surface. Consequently, the dimensions of the projection surface can advantageously be reduced, which reduces the required installation space.

Preferably, a light image comprises at least one deictic sign (direction-indicating signs) and/or an iconic sign (a sign having similarity) and/or a symbolic sign (arbitrary sign) and/or an alphanumeric sign. One example of a deictic sign is an indicating arrow, one example of an iconic sign is a pictogram or ideogram comprising a pictorial representation (e.g. a schematically represented battery), and one example of a symbolic sign is an abstract representation of an underlying state. Such signs are customary for representing specific states in the context of various devices. Therefore, the information content conveyed in each case is able to be comprehended by a human particularly rapidly.

Furthermore, other light image effects can also be taken into account, for example color codings and the like, in order to represent different vehicle states.

Preferably, the cover at least partly forms a bench seat. The illuminant is then arranged on an underside of the bench seat. This ensures that a projection direction of the illuminant is oriented in the direction of a vehicle interior, in particular oppositely to a usual seated position of a user of the vehicle. A direct perception of light emitted by the illuminant is reliably avoided by means of the bench seat.

In addition, provision can be made for a light image generated by the illuminant not to be directly perceptible according to a usual seated position of a driver themself. Consequently, this prevents influencing of the driver in the seated position themself in relation to the generated light image.

Alternatively or additionally, the bench seat comprises a front section and a rear section. The at least one illuminant is then arranged on the underside of a part of the front section in such a way that the illuminant has a height offset relative to the underside of the rear section. If the bench seat is combined with a component part of the vehicle that has a planar surface below the bench seat, an interspace for projection purposes can then be formed particularly efficiently between the front section of the bench seat and the corresponding component part. The interspace is then formed at least partly in the vertical direction, particularly if the vehicle is arranged according to an upright position (for example in the driving position). The front section of the bench seat itself prevents the direct perception of the generated light image by the driver (in the usual seated position).

Optionally, the underside of the front section and the underside of the rear section of the bench seat can form an obtuse angle in a vertical cross-section of the single-track vehicle which leads through a longitudinal axis and a vertical axis of the vehicle. As a result, in a particularly simple manner, provision is made of a height difference between the front section and the rear section of the bench seat in relation to the vertical direction, and a slot in which the projection surface is present.

Alternatively or additionally, the cover can comprise an at least partly transparent section. The at least partly transparent section is arranged in such a way that a generated light image on the projection surface is visible through this section. By way of example, the at least partly transparent section can comprise a light-transmissive window device which is incorporated into the cover or is enclosed by the latter. The window device can then comprise a glass, quartz glass or a light-transmissive plastic. This affords the possibility of perceiving the generated light image, despite the cover, from an opposite side of the cover with respect to the illuminant. Advantageously, a direct perception of the light emitted by the illuminant is nevertheless prevented.

The transparency of the section, in particular for light perceptible to the human eye under normal conditions, can be 50% or more, preferably 70% or more, more preferably 90% or more.

Proceeding from the at least partly transparent section, the illuminant can also be arranged in such a way that a projection direction of the emitted light is oriented away from the section. The section can also comprise a blackened portion in the region of the illuminant. This affords additional measures for limiting the visual influencing of a driver in the seated position.

The at least one projection surface can be formed as a surface of an opaque and/or matt material. Specularly reflective effects can thus be avoided, for example, whereby visual irritations are avoided.

The illuminant can comprise in particular one or more light emitting diodes. A light emitting diode can be of a single color or multicolored. Light emitting diodes are distinguished by a low power consumption in conjunction with comparatively high luminous efficiency.

The invention and further advantageous embodiments and developments thereof are described and explained in greater detail below on the basis of the examples illustrated in the drawings. The features that can be gathered from the description and the drawings can be applied according to the invention individually by themselves or as a plurality in any desired combination.

### BRIEF DESCRIPTION OF THE DRAWINGS

FIG. 1 is a schematic drawing of a vehicle with a vehicle state display and a controller; and

FIG. 2 is a schematic drawing of the vehicle state display.

### DETAILED DESCRIPTION OF THE DRAWINGS

All features disclosed below in relation to the exemplary embodiments and/or the accompanying figures can be combined by themselves or in any desired subcombination with features of the aspects of the present disclosure, including features of preferred embodiments, provided that the resulting feature combination is expedient for a person skilled in the art in the technical field.

For the purposes of the present disclosure, the wording “at least one out of A, B and C” means for example (A), (B), (C), (A and B), (A and C), (B and C) or (A, B and C), including all further possible combinations if more than three elements are listed. In other words, the expression “at least one out of A and B” generally means “A and/or B”, namely “A” by itself, “B” by itself or “A and B”.

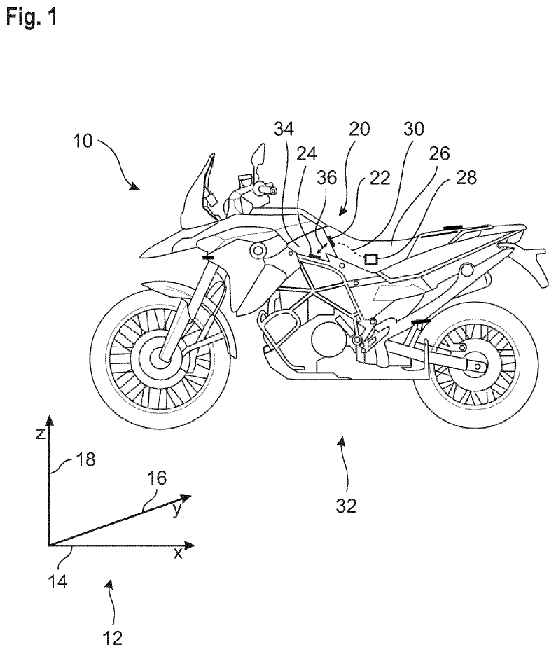

FIG. 1 shows a schematic drawing of a vehicle 10 with a vehicle state display 20 and a controller 28.

The controller 28 is e.g. the central control unit of the vehicle, having access to all state data of the vehicle.

In the present case, the vehicle 10 is oriented on a single track according to a Cartesian coordinate system 12. Here the vehicle 10 is arranged in an upright position. Other vehicle positions affect the relative orientations accordingly. The geometric explanations should be applied accordingly. The longitudinal axis of the vehicle 10 is oriented along the x-axis 14, the transverse axis of the vehicle 10 is oriented along the y-axis 16, and the vertical axis of the vehicle 10 is oriented along the z-axis 18 of the coordinate system 12. In other words, the vehicle 10 is arranged according to its usual position of use.

The vehicle state display 20 comprises an illuminant 22, a projection surface 24 and a cover 26. The illuminant 22 is coupled to a controller 28 of the vehicle 10 with the aid of a signal line 30 (dotted).

The projection surface 24 is provided in particular in the region of the lateral outer skin of the vehicle and at a distance from the driver's display.

The cover 26 is arranged in relation to the illuminant 22 in such a way that light emitted by the illuminant 22 is not directly perceptible to a human eye from surroundings 32 of the vehicle 10. Rather, the emitted light is exclusively indirectly perceptible from the surroundings 32, i.e. at least simply reflected, refracted, and/or diffracted.

An interspace 34 is formed between the illuminant 22 and the projection surface 24, the projection direction 36 (arrow) of the illuminant 22 running through the interspace. Access to the interspace 34 is limited by the surrounding components of the vehicle 10, such that the interspace 34 is not reachable for a human eye. Direct incidence of light from the illuminant 22 into a human eye situated in the surroundings 32 is therefore prevented by the cover 26 and the structural geometry of the vehicle 10.

The controller 28 can be coupled to further electrical or electronic components of the vehicle 10. By way of example, the controller 28 can be coupled to an energy storage device of the vehicle 10. The controller 28 comprises pieces of information about different vehicle states. In the present case, different vehicle states can also relate to different vehicle parameters.

The illuminant 22 is coupled to the controller 28 in such a way that vehicle states detected or determined by the controller 28 are representable by the illuminant 22 generally with the aid of light images generated on the projection surface 24, which will be explained in greater detail below.

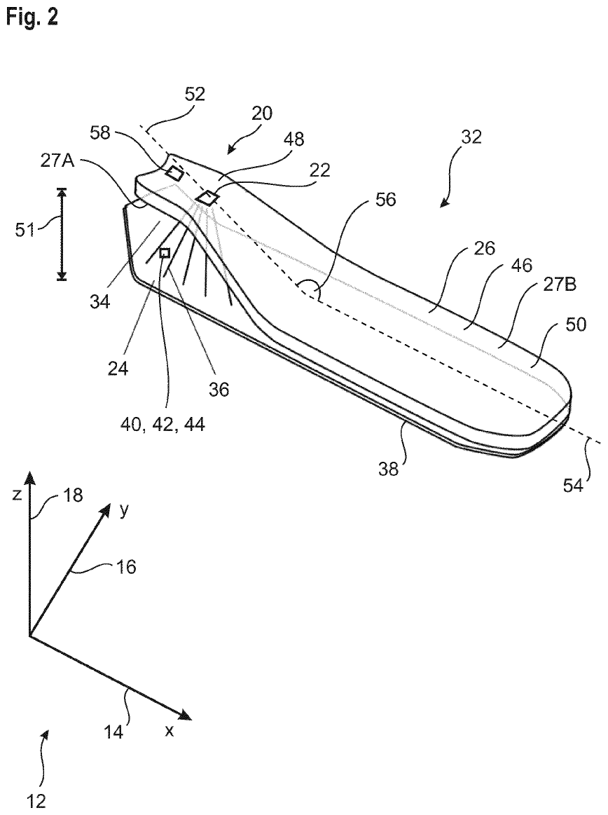

FIG. 2 shows a schematic drawing of the vehicle state display 20. The cover 26 comprises an underside 27A and an opposite top side 27B along the vertical axis of the vehicle 10 corresponding to the z-axis 18 of the coordinate system 12. The illuminant 22 is arranged on the underside 27A of the cover 26 and, as viewed from the top side 27B of the cover 26, is concealed by the cover 26.

The interspace 34 is formed in particular in an at least partly vertical direction along the z-axis 18 between the cover 26 and a component 38 of the vehicle 10, the component being arranged opposite the cover 26. The component 38 can be, for example, an engine/motor housing part, a fuel tank housing part or an energy storage device housing part. The projection surface 24 is provided by at least one part of the surface of the component 38.

On the basis of control signals of the controller 28, the illuminant 22 can generate at least one first light image 40 and a second light image 42 different therefrom on the projection surface 24. The first light image 40 represents a first vehicle state detected or determined by the controller 28. The second light image 42 represents a second vehicle state detected or determined by the controller 28, the second vehicle state being different from the first. By way of example, within an overlapping region 44 of the projection surface 24, firstly a battery pictogram in a green color can be displayed in order to indicate that the state of charge of an energy storage device of the vehicle 10 is equal to or above a predetermined threshold value. In the same overlapping region 44 of the projection surface 24, however, a battery pictogram in a red color can also be displayed in order to indicate that the state of charge of the energy storage device of the vehicle 10 has fallen below the predetermined threshold value.

It goes without saying that the light images 40, 42 can display a multiplicity of different vehicle states simultaneously. Moreover, a multiplicity of different light images 40, 42 can be displayable in order to represent a wide variety of vehicle states. In addition, there can be a plurality of illuminants 22, to which the controller 28 is able to apply control signals separately and/or in grouped fashion and/or jointly in order to generate corresponding light images 40, 42.

The projection surface 24 is provided in a gap of the outer skin of the vehicle, in particular a gap on a side surface of the vehicle, here between the bench seat and an underlying frame or, if present, the frame covering.

In the present case, the cover 26 at least partly forms a bench seat 46 of the vehicle 10. The illuminant 22 is arranged in a front section 48 of the bench seat 46. The front section 48 is offset relative to a rear section 50 along the z-axis 18 of the coordinate system 12. Therefore, the illuminant 22 arranged on the underside 27A of the front section 48 has a height offset 51 relative to the underside 27A of the rear section 50 of the bench seat. As a result, the interspace 34, i.e. the gap, is created in a particularly simple manner along the vertical axis of the vehicle 10.

In the present case, the front section 48 of the bench seat 46 is arranged in an angled manner relative to the rear section 50. That means that a first surface tangent 52 following the surface contour of the front section 48 and a second surface tangent 54 following the surface contour of the rear section 50 form an obtuse angle 56.

In this case, the surface tangents 52, 54 are formed in a cross-sectional area of the vehicle 10 which is spanned by a longitudinal axis and a vertical axis of the vehicle 10, i.e. here along the x-axis 14 and the z-axis 18 of the coordinate system 12.

Optionally, the cover 26 can comprise an at least partly transparent section 58. The at least partly transparent section 58 is arranged in such a way that a light image 40, 42 generated on the projection surface 24 is perceptible from the top side 27B of the cover 26. The section 58 comprises a material that has a transparency of 50% or more, preferably 70% or more, more preferably 90% or more, for light emitted by the at least one illuminant 22 within the spectrum of the human eye (under normal conditions).

In the present application, reference may be made to amounts and numbers. Unless expressly indicated, such amounts and numbers should not be regarded as limiting, but rather as examples of the possible amounts or numbers in association with the present application. In this context, the term “plurality” may also be used in the present application to refer to an amount or a number. In this context, the term “plurality” means any number that is greater than one, for example two, three, four, five, etc. The terms “about”, “approximately”, “close to”, etc., mean plus or minus 5% of the indicated value.

1.-10. (canceled)

11. A single-track vehicle, comprising:
a controller;
a vehicle state display comprising at least one projection surface, a cover and at least one illuminant, wherein
the at least one illuminant is coupled to the controller,
the at least one illuminant and the cover are arranged such that light emitted by the at least one illuminant is perceptible only indirectly from outside the vehicle, and
the illuminant is designed to generate at least one first light image corresponding to a first vehicle state and a second light image corresponding to a second vehicle state on the projection surface based on control signals of the controller, the first light image and the second light image being different.

12. The single-track vehicle according to claim 11, wherein
the light emitted by the at least one illuminant is perceptible to a human from surroundings of the single-track vehicle not in an unreflected manner and/or not in an unrefracted manner and/or not in an undiffracted manner.

13. The single-track vehicle according to claim 11, wherein
an interspace is arranged between the at least one projection surface and the cover, and
the interspace is delimited at least partly for the single-track vehicle along a vertical direction by the cover and a further component of the single-track vehicle, the further component being situated opposite the interspace.

14. The single-track vehicle according to claim 13, wherein
the at least one projection surface and the cover are arranged such that a light image generated on the at least one projection surface by the at least one illuminant is perceptible from the surroundings of the single-track vehicle.

15. The single-track vehicle according to claim 14, wherein the light image is perceptible from a side of the single-track vehicle.

16. The single-track vehicle according to claim 11, wherein
the first light image and the second light image are generated within an at least partly overlapping region of the projection surface.

17. The single-track vehicle according to claim 11, wherein
the first or second light image comprise at least one of: a deictic sign, an iconic sign, a symbolic sign, or an alphanumeric sign.

18. The single-track vehicle according to claim 11, wherein
the cover at least partly forms a bench seat, and
the at least one illuminant is arranged on an underside of the bench seat.

19. The single-track vehicle according to claim 18, wherein
the bench seat comprises a front section and a rear section, and
the at least one illuminant is arranged on the underside of a part of the front section such that the illuminant has a height offset relative to the underside of the rear section.

20. The single-track vehicle according to claim 19, wherein
the underside of the front section and the underside of the rear section of the bench seat form an obtuse angle in a vertical cross-section of the single-track vehicle which leads through a longitudinal axis and a vertical axis of the vehicle.

21. The single-track vehicle according to claim 11, wherein
the cover comprises an at least partly transparent section, through which a generated light image on the projection surface is visible.
